(19) United States
(12) Patent Application Publication
(10) Pub. No.: US 2025/0146237 A1
(43) Pub. Date: May 8, 2025

(54) ROAD SURFACE EVALUATION APPARATUS

(71) Applicant: Honda Motor Co., Ltd., Tokyo (JP)

(72) Inventors: Hiroyuki Onimaru, Tokyo (JP); Takeo Tokunaga, Tokyo (JP); Atsuki Kakinuma, Tokyo (JP); Yasuo Oishi, Tokyo (JP); Akira Iihoshi, Tokyo (JP)

(21) Appl. No.: 18/835,721

(22) PCT Filed: Feb. 8, 2023
(86) PCT No.: PCT/JP2023/004165

§ 371 Date: Aug. 3, 2024

(30) Foreign Application Priority Data
Feb. 10, 2022 (JP) 2022-019139

(51) Int. Cl. E01C 23/01; G01B 21/30; G01M 17/04

(52) U.S. Cl. CPC E01C 23/01; G01B 21/30; G01M 17/04

(57) ABSTRACT

A road surface evaluation apparatus includes a microprocessor configured to perform: acquiring driving information of a plurality of vehicles which are traveling, including acceleration information, speed information, and position information; acquiring map information including information of a road on which the plurality of vehicles travel; deriving a road surface roughness value representing a roughness of a road surface on which the plurality of vehicles travel for each speed range based on the acquired driving information of each of the plurality of vehicles; correcting, for each speed range, the road surface roughness values derived for each speed range, and combining the road surface roughness values corrected for each speed range to derive a corrected road surface roughness value; and outputting the corrected road surface roughness value in association with the information of the road.

### CROSS-REFERENCE TO RELATED APPLICATION

This application is a National Stage of PCT international application Ser. No. PCT/JP2023/004165 filed on Feb. 8, 2023 which designates the United States, incorporated herein by reference, and which is based upon and claims the benefit of priority from Japanese Patent Application No. 2022-019139, filed on Feb. 10, 2022, the entire contents of which are incorporated herein by reference.

### TECHNICAL FIELD

This invention relates to a road surface evaluation apparatus that evaluates a road surface profile representing unevenness of a road surface.

As a prior-art apparatus of this type, it is known that a road surface profile representing the unevenness of the road surface on which a vehicle has traveled is detected based on the acceleration in the lateral direction (lateral to the driving direction) measured by an acceleration sensor installed in the vehicle (see, for example, Patent Literature 1).

### CITATION LIST

### Patent Literature

Patent Literature 1: Japanese Unexamined Patent Publication No. 2002-12138

### DISCLOSURE OF INVENTION

### Problems to be Solved by the Invention

However, the road surface profile detected based on the acceleration measured by the acceleration sensor will vary depending on a driving speed of the vehicle. Therefore, simply detecting the road surface profile based on the acceleration measured by the acceleration sensor, as in the apparatus described in Patent Literature 1 above, does not sufficiently evaluate the road surface profile.

### Means for Solving Problem

An aspect of the present invention is a road surface evaluation apparatus including: a driving information acquisition unit configured to acquire driving information of a plurality of vehicles which are traveling, including acceleration information indicating accelerations of the plurality of vehicles, speed information indicating driving speeds of the plurality of vehicles, and position information of the plurality of vehicles; a map information acquisition unit configured to acquire map information including information of a road on which the plurality of vehicles travel; a roughness value derivation unit configure to derive a road surface roughness value representing a roughness of a road surface on which the plurality of vehicles travel for each speed range based on the driving information of the plurality of vehicles acquired by the driving information acquisition unit; a roughness value correction unit configured to correct, for each speed range, the road surface roughness values for each speed range derived by the roughness value derivation unit, and combine the road surface roughness values corrected for each speed range to derive a corrected road surface roughness value; and an output unit configured to output the corrected road surface roughness value derived by the roughness value correction unit in association with the information of the road acquired by the map information acquisition unit.

### Effect of the Invention

The present invention allows adequate evaluation of road surface profiles.

### BRIEF DESCRIPTION OF THE DRAWINGS

FIG. 1 is a diagram illustrating an example of a configuration of a road surface evaluation system including a road surface evaluation apparatus according to an embodiment of the present invention;

FIG. 2 is a block diagram illustrating key components of an in-vehicle device.

FIG. 3 is a block diagram illustrating key components of the road surface evaluation apparatus according to the embodiment of the present invention;

FIG. 4A is a diagram illustrating how the correlation between road surface roughness values and lateral acceleration is derived;

FIG. 4B is a diagram illustrating how the correlation between road surface roughness values and lateral acceleration is derived;

FIG. 5A is a diagram illustrating an example of a map of a road on which a vehicle is driving;

FIG. 5B is a diagram illustrating an example of driving information acquired by the road surface evaluation apparatus from the in-vehicle device of the vehicle that has traveled the road in FIG. 5A;

FIG. 6A is a diagram illustrating an example of a road surface roughness value derived based on the driving information acquired from in-vehicle devices of vehicles which travel on the road in FIG. 5A;

FIG. 6B is a diagram illustrating another example of a road surface roughness value derived based on the driving information acquired from in-vehicle devices of vehicles which travel on the road in FIG. 5A

FIG. 7 is a flowchart illustrating an example of processing executed by the processing unit in FIG. 3; and

FIG. 8 is a diagram illustrating an example of vehicle information.

### DESCRIPTION OF EMBODIMENT

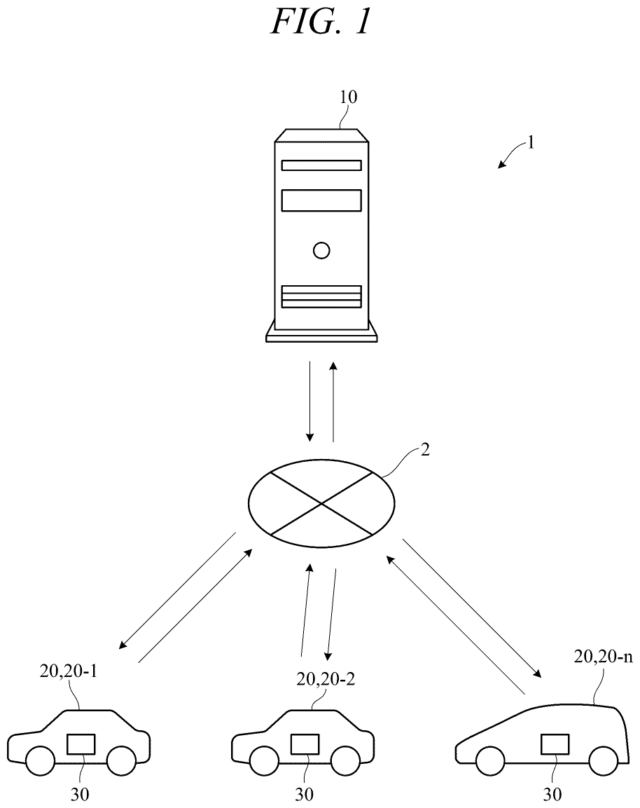

An embodiment of the present invention will be described below with reference to FIGS. 1 to 8. The road surface evaluation apparatus according to the present embodiment is an apparatus for evaluating the road surface profile of a road on which a vehicle is traveling. FIG. 1 illustrates an example of the configuration of a road surface evaluation system including a road surface evaluation apparatus according to the present embodiment. As illustrated in FIG. 1, the road surface evaluation system 1 includes a road surface evaluation apparatus 10 and an in-vehicle device 30. The road surface evaluation apparatus 10 is configured as a server device. The in-vehicle device 30 is configured to communicate with the road surface evaluation apparatus 10 via a communication network 2.

The communication network 2 includes not only public wireless communication networks represented by Internet networks and cell phone networks, but also closed communication networks established for each predetermined administrative region, such as wireless LAN, Wi-Fi (registered trademark), and Bluetooth (registered trademark).

The in-vehicle device 30 is installed in various a vehicle 20. The vehicle 20 includes a plurality of vehicles 20-1, 20-2, . . . , 20-n The vehicle 20 may be a manual driving vehicle or a self-driving vehicle. The vehicle 20 may include vehicles of which the models or grades are different.

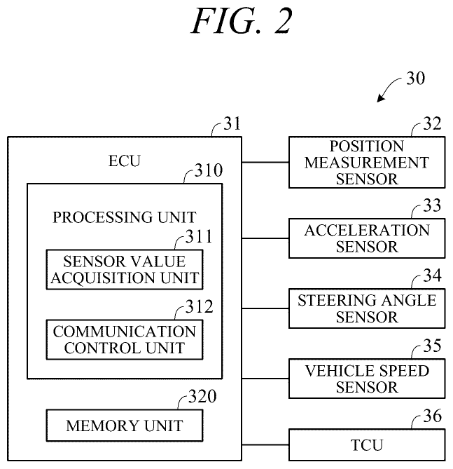

FIG. 2 is a block diagram illustrating the key components of the in-vehicle device 30 according to the present embodiment. The in-vehicle device 30 has an electronic control unit (ECU) 31, a position measurement sensor 32, an acceleration sensor 33, a steering angle sensor 34, a vehicle speed sensor 35, and a telematic control unit (TCU) 36.

The position measurement sensor 32 is, for example, a GPS sensor, which receives positioning signals transmitted from GPS satellites and detects the absolute position (e.g., latitude and longitude) of the vehicle 20. The position measurement sensor 32 includes not only GPS sensors but also sensors that use radio waves transmitted from satellites in various countries, known as GNSS satellites, including quasi-zenith orbit satellites. Alternatively, the vehicle position may be determined by a hybrid method with inertial navigation.

The acceleration sensor 33 detects the acceleration of the vehicle 20 in the left-right directions, that is, lateral acceleration. The acceleration sensor 33 may be configured to detect acceleration in the front-back direction and vertical direction as well as lateral acceleration of the vehicle 20. The steering angle sensor 34 detects the steering angle of the steering wheel (not shown) of the vehicle 20. The vehicle speed sensor 35 detects the vehicle speed of the vehicle 20.

As illustrated in FIG. 2, the ECU 31 includes a computer including a processing unit 310 such as a CPU (processor), a memory unit 320 such as ROM and RAM, and other peripheral circuits such as I/O interfaces not illustrated. The processing unit 310 functions as a sensor value acquisition unit 311 and a communication control unit 312 by executing a program stored in the memory unit 320 in advance.

The sensor value acquisition unit 311 acquires information (values) detected by each of the sensors 32 to 35. Particularly, the sensor value acquisition unit 311 acquires lateral acceleration detected by the acceleration sensor 33, a driving speed detected by the vehicle speed sensor 35, and the absolute position of the vehicle 20 detected by the position measurement sensor 32 at a predetermined cycle, for example, every 10 ms. The communication control unit 312 transmits the information acquired by the sensor value acquisition unit 311 (hereinafter referred to as driving information) to the road surface evaluation apparatus 10 via the TCU 36, together with the detection time information indicating the detection time thereof and the vehicle ID that can identify the vehicle 20 (vehicle identification information). At this time, the communication control unit 312 transmits the information acquired by the sensor value acquisition unit 311 at a predetermined cycle. More specifically, the communication control unit 312 transmits the information acquired by the sensor value acquisition unit 311 in intervals of, for example, 1 s so as not to increase the processing load and not to unnecessarily squeeze the bandwidth of the communication network 2.

The road surface evaluation apparatus 10 detects the unevenness of the road surface, that is, the road surface roughness (hereinafter also referred to as a road surface profile), based on the values detected by the acceleration sensor 33 of the vehicle 20 (in-vehicle device 30). The detected road surface profile is output to a terminal owned by, for example, a road management company, and is used as reference data by the road management company when considering whether or not repairs are necessary. That is, the detected values of the acceleration sensor 33 are used to evaluate the road surface profile.

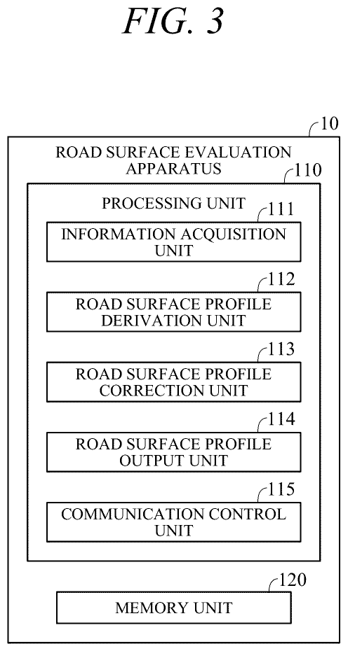

FIG. 3 is a block diagram illustrating the key components of the road surface evaluation apparatus 10 according to the present embodiment. The road surface evaluation apparatus 10 is configured to include a computer including a processing unit 110, such as a CPU, a memory unit 120 such as ROM and RAM, and other peripheral circuits such as I/O interfaces not illustrated. The memory unit 120 stores map information including road maps, and various information processed by the processing unit 110.

The processing unit 110 functions as an information acquisition unit 111, a road surface profile derivation unit 112, a road surface profile correction unit 113, a road surface profile output unit 114, and a communication control unit 115 by executing programs stored in the memory unit 120.

The information acquisition unit 111 acquires driving information. In more detail, the information acquisition unit 111 receives the driving information from the in-vehicle device 30 of each of the plurality of vehicles 20 traveling on the road, via the communication control unit 115. Note that the information acquisition unit 111 can identify the vehicle 20 that is the transmission source of the driving information by the vehicle ID associated with the driving information.

The information acquisition unit 111 stores driving information received from the plurality of vehicles 20 (in-vehicle devices 30) in the memory unit 120 in time series. Hereafter, the driving information stored in time series in the memory unit 120 is referred to as time-series driving information. The information acquisition unit 111 also acquires map information from the memory unit 120, including information on the road on which the vehicles 20 are driving.

The road surface profile derivation unit 112 derives roughness information indicating the amount of unevenness (depth or height) of the road surface, or road surface roughness, based on the driving information acquired by the information acquisition unit 111. Roughness information is a road surface roughness value that indicates the degree of roughness of the road surface, for example, the value expressed by the International Roughness Index (IRI), which is an international index. Hereinafter, the road surface roughness values may be simply referred to as roughness values.

In general, the greater the amount of unevenness of the road surface, the greater the lateral acceleration of the vehicles 20, and the road surface roughness values and the lateral acceleration have a certain correlation. The road surface profile derivation unit 112 uses this correlation to derive the road surface roughness value corresponding to the vehicle position on the road from the lateral acceleration. Specifically, the road surface profile derivation unit 112 first derives a correlation between road surface roughness values and lateral acceleration based on the previously measured road surface roughness values and lateral acceleration.

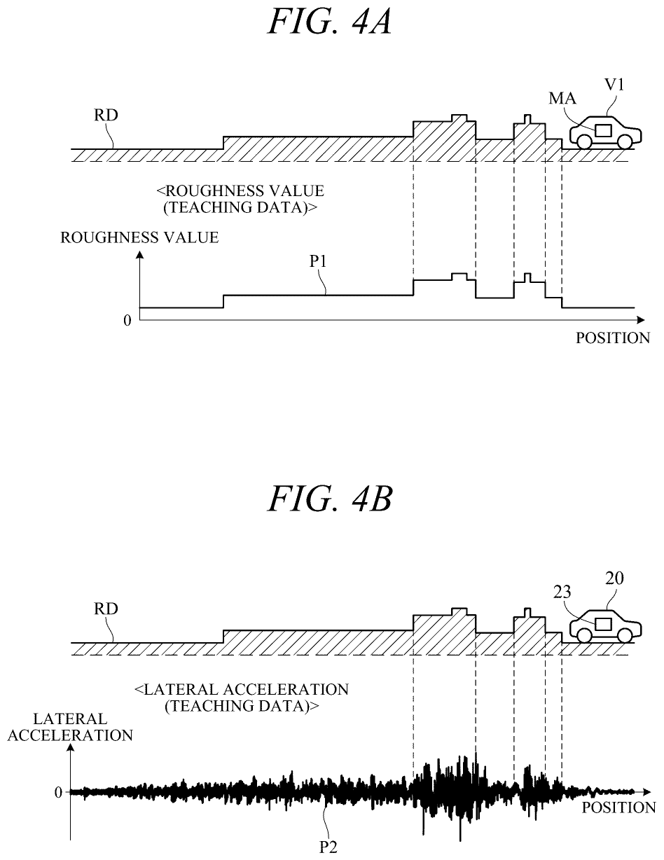

FIGS. 4A and 4B illustrate how the correlation between road surface roughness values and lateral acceleration is derived. A vehicle V1 illustrated in FIG. 4A is a special vehicle including a measuring instrument MA that measures road surface roughness. When the vehicle V1 is driving on a predetermined road (such as a course for measurement) RD, the measuring instrument MA measures road surface roughness values of the road RD. A characteristics P1 in FIG. 4A represents the road surface roughness values measured at this time, that is, the road surface roughness values used as the training data.

FIG. 4B illustrates the vehicle 20 in FIG. 1 driving on the same road RD as that in FIG. 4A. A characteristic P2 in FIG. 4B represents the lateral acceleration detected by the acceleration sensors 33 installed in the vehicles 20, that is, the lateral acceleration used as the training data, while the vehicles 20 are driving on the predetermined road RD.

The training data for road surface roughness values and lateral acceleration may be stored in the memory unit 120 of the road surface evaluation apparatus 10 or in an external memory device. The road surface profile derivation unit 112 executes machine learning using the training data for road surface roughness values and lateral acceleration read from the memory unit 120 or an external storage device to derive the correlation between the road surface roughness values and the lateral acceleration. A driving speed, front/rear acceleration, and a steering angle may be added as training data for machine learning.

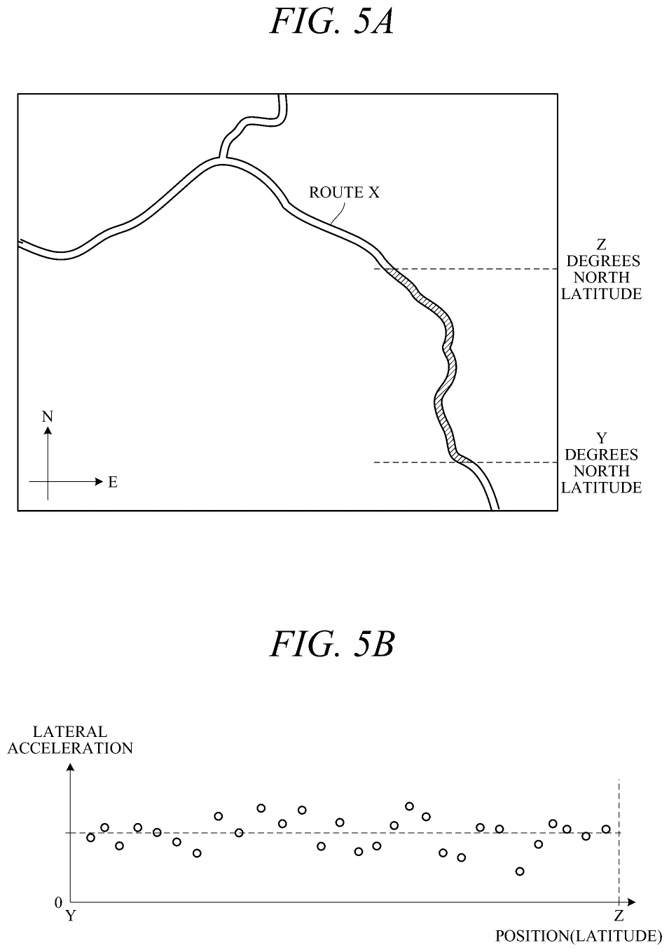

FIG. 5A illustrates an example of a map of the road on which the vehicle 20 is driving. FIG. 5A illustrates a predetermined road (a section with latitude Y to Z on National Route X) to be evaluated for road surface roughness. In FIG. 5A, the upper direction corresponds to the north direction, and the right direction corresponds to the east direction. A range to be evaluated for road surface roughness (hereinafter referred to the road to be evaluated) can be designated by a user as will be described later. In a case where the road to be evaluated has a plurality of lanes on each side, a lane to be evaluated for road surface roughness is designated by the user. FIG. 5B illustrates an example of driving information acquired by the road surface evaluation apparatus 10 from the in-vehicle device 30 of the vehicle 20 that drove on the predetermined road (the section of latitude Y to Z on National Route X) in FIG. 5A. The horizontal axis in the figure is a position (latitude) of the vehicle 20 in a driving direction along a traveling lane, and the vertical axis is the lateral acceleration of the vehicle 20.

A degree of shock applied to a vehicle due to unevenness of a road surface varies depending on a driving speed of the vehicle and increases as the driving speed increases. Therefore, even in a case where a plurality of vehicles 20 travel on the same road (for example, the predetermined road in FIG. 5A), the road surface roughness values derived based on driving information (lateral acceleration) of the individual vehicles are different from each other, when driving speeds of the individual vehicles are different.

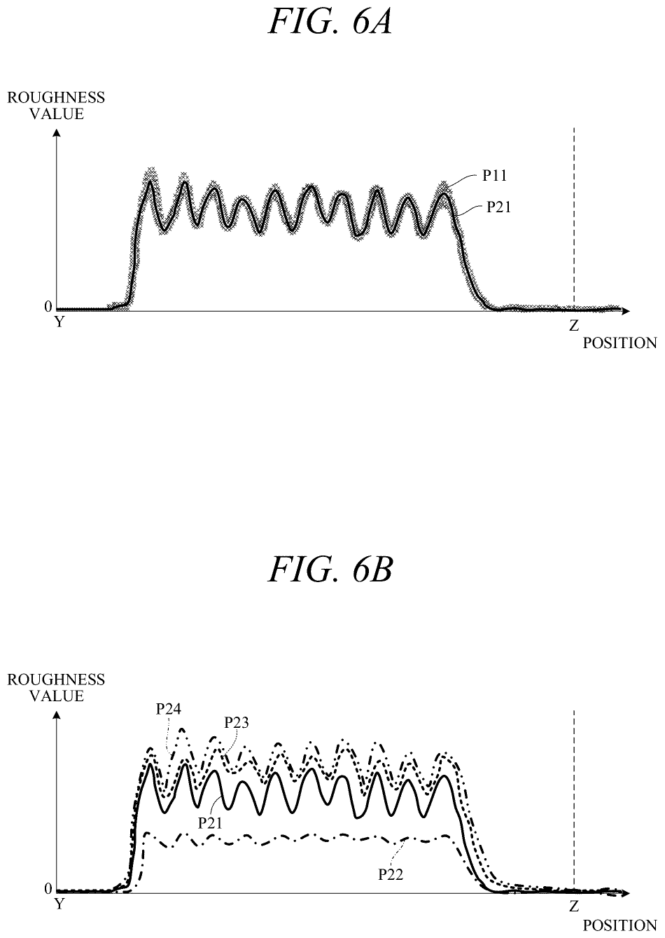

FIGS. 6A and 6B are graphs illustrating examples of road surface roughness values derived based on driving information (lateral acceleration) acquired from the in-vehicle devices 30 of the plurality of vehicles 20 driving on the predetermined road in FIG. 5A. FIG. 6A illustrates an example of a road surface roughness value derived based on the driving information acquired from the in-vehicle devices 30 of the plurality of vehicles 20 which travel on the predetermined road in FIG. 5A in the same speed range (the driving speed of 30 to 39 km/h). A characteristic P11 represented by crosses in FIG. 6A denotes road surface roughness values derived based on the driving information acquired from the in-vehicle devices 30 of the plurality of vehicles 20 which travel at a driving speed of 30 to 39 km. A characteristic P21 represented by a solid line denotes a representative value of the road surface roughness values denoted by the characteristic P11 at respective traveling positions. The representative value is, for example, an average value or a median value.

FIG. 6B illustrates an example of a road surface roughness value derived based on driving information of the plurality of vehicles 20 which travel on the predetermined road in FIG. 5A in different speed ranges. FIG. 6B illustrates characteristics P22, P23, and P24 in addition to the characteristic P21 in FIG. 6A. The characteristic P22 denotes a representative value of road surface roughness values derived based on driving information of the plurality of vehicles 20 which travel at a driving speed of 10 to 19 km/h. The characteristic P23 denotes a representative value of road surface roughness values derived based on driving information of the plurality of vehicles 20 which travel at a driving speed of 40 to 49 km/h. The characteristic P24 denotes a representative value of road surface roughness values derived based on driving information of the plurality of vehicles 20 which travel at a driving speed of 50 to 59 km/h. In FIG. 6B, in order to simplify the drawing, a road surface roughness value (representative value) corresponding to a speed range other than the speed range described above is not illustrated.

As described above, even in a case where the plurality of vehicles 20 travel on the same road, the road surface roughness value derived based on the driving information of each vehicle varies for each speed range. In consideration of this point, the road surface profile derivation unit 112 divides individual items of the driving information for each speed range on the basis of the driving speed of the vehicle 20 included in the driving information. For each speed range, the road surface profile derivation unit 112 derives road surface roughness values for individual items of driving information included in the same speed range, and derives a representative value thereof. Furthermore, the road surface profile correction unit 113 corrects the representative value of the road surface roughness values derived for each speed range by the road surface profile derivation unit 112, using a correction factor corresponding to each speed range.

Specifically, the road surface profile correction unit 113 combines representative values of the road surface roughness values derived for each speed range, using the following expression (i). A value derived by this combination is referred to as a corrected road surface roughness value.

CR(x)=(D1(x)×K1+D2(x)×K2+ . . . +Dn(x)×Kn)/n (i)

Note that CR denotes a corrected road surface roughness value. Here, x denotes a traveling position of the vehicle 20, and CR(x) denotes CR derived based on the driving information acquired at a traveling position x. D1 denotes a representative value of road surface roughness values derived based on driving information of a plurality of vehicles 20 which travel in a speed range VR1. D2 denotes a representative value of road surface roughness values derived based on driving information of a plurality of vehicles 20 which travel in a speed range VR2 (>VR1). Dn denotes a representative value of road surface roughness values derived based on driving information of a plurality of vehicles 20 which travel in a speed range VRn (>VRn−1). Dn(x) denotes Dn derived based on driving information acquired at the traveling position x. In addition, Kn denotes a correction factor corresponding to the speed range VRn, and Kn is set to a value smaller than Kn−1. That is, the higher the speed range, the smaller the correction factor is assigned. It is assumed that a value of Kn is stored in the memory unit 120 in advance. Note that the value of Kn may be set or changed by the user via an operation unit (not illustrated) or the like included in the road surface evaluation apparatus 10.

The road surface profile output unit 114 outputs the corrected road surface roughness values derived by the road surface profile correction unit 113 in association with the road information acquired by the information acquisition unit 111.

The communication control unit 115 controls a communication unit (not illustrated) to transmit and receive data to and from external devices and others. In more detail, the communication control unit 115 transmits and receives data via the communication network 2 to and from the in-vehicle device 30 of the vehicle 20 and terminals of road management companies or the like. The communication control unit 115 also receives, via the communication network 2, a road surface profile output instruction transmitted from the terminals of road management companies or the like. In addition, the communication control unit 115 acquires map information and other information from various servers connected to the communication network 2 periodically or at arbitrary times. The communication control unit 115 stores, in the memory unit 120, information that has been acquired from various servers.

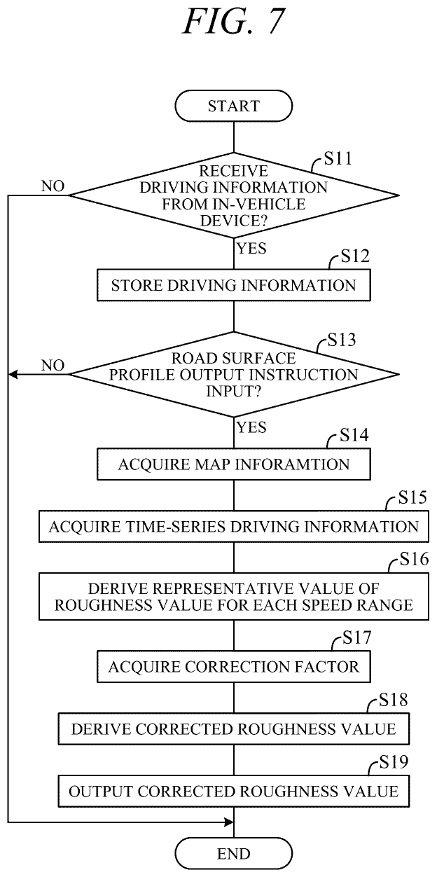

FIG. 7 is a flowchart illustrating an example of processing executed by the processing unit 110 (CPU) of the road surface evaluation apparatus 10 according to a predetermined program. The processing illustrated in this flowchart is repeated at a predetermined cycle while the road surface evaluation apparatus 10 is running. First, in step S11, it is determined whether driving information has been received from the in-vehicle device 30 of the vehicle 20. If NO in step S11, the processing ends.

If YES in step S11, in step S12, the driving information received in step S11 is stored in the memory unit 120 together with the vehicle ID associated with the driving information. In step S13, it is determined whether or not a road surface profile output instruction has been input (received). The road surface profile output instruction includes section information that can identify the road to be evaluated. The section information is information that indicates the name and section of the road to be evaluated, for example, “road: National Route X, section: latitude Y to Z”. When the road has a plurality of lanes on each side, such as two lanes on one side, the section information may include information on the lane to be evaluated, such as “road: National Route X, lane: right end, section: latitude Y to Z”. Information other than latitude may be used to specify the section to be evaluated. For example, longitude may be used instead of latitude or in addition to latitude. Alternatively, the distance from the start point of the section may be used. The road surface profile output instruction further may include period information specifying a predetermined period to be evaluated. The period information includes information that can identify the period to be evaluated, for example, “the past one month from ◯ month ◯” or “within the past year from the present”.

If NO in step S13, the processing ends. If YES in step S13, in step S14, map information is read from the memory unit 120 and road information included in the map information is acquired. In step S15, driving information (time-series driving information) of the vehicles 20 is acquired from the memory unit 120. In more detail, based on section information included in the road surface profile output instruction and the road information acquired in step S14, driving information corresponding to the road to be evaluated which is identified by the section information is read from the memory unit 120. Note that, when the section information and period information are included in the road surface profile output instruction, of items of the driving information corresponding to the road to be evaluated which is identified by the section information, driving information acquired during a predetermined period designated by the period information is read from the memory unit 120.

In step S16, individual items of driving information are divided for each speed range on the basis of the speed information included in the individual items of driving information read from the memory unit 120 in step S15. The roughness of the road surface is evaluated for each speed range. Specifically, for each speed range, road surface roughness values are derived for the individual items of driving information included in the same speed range, and a representative value thereof is derived. In step S17, a correction factor corresponding to each speed range is read from the memory unit 120. In step S18, the corrected road surface roughness value is derived based on the above expression (i), using the representative value of the road surface roughness values of each speed range derived in step S16 and the correction factor of each speed range read in step S17.

In step S19, information obtained by associating the corrected road surface roughness value derived in step S18 with the road information acquired in step S14, that is, road surface profile information, is generated and output. In more detail, the corrected road surface roughness value (CR(x)) derived in step S18 is output in association with each position (x) in the section to be evaluated. The road surface profile information is output via the communication network 2 to a terminal from which the road surface profile output instruction is transmitted or to a predetermined output destination terminal. The road surface profile information is information that can be displayed on a display device such as a display, and users can check and evaluate road surface profiles by displaying the road surface profile information on a display included in the user's terminal.

According to the embodiment of the present invention, the following effects can be achieved.
(1) The road surface evaluation apparatus 10 includes: the information acquisition unit 111 that acquires driving information of the plurality of individual vehicles 20 which includes acceleration information indicating accelerations of the plurality of vehicles 20 which are traveling, speed information indicating driving speeds of the plurality of vehicles 20, and position information of the plurality of vehicles 20, and that acquires map information including information about the road on which the plurality of vehicles 20 travel; the road surface profile derivation unit 112 that derives the road surface roughness value representing roughness of the road surface on which the plurality of vehicles 20 travel for each speed range on the basis of the driving information of the plurality of individual vehicles 20 acquired by the information acquisition unit 111; the road surface profile correction unit 113 that corrects, for each speed range, the road surface roughness values for each speed range derived by the road surface profile derivation unit 112, and combines the corrected road surface roughness values for each speed range to derive the corrected road surface roughness value; and the road surface profile output unit 114 that outputs the corrected road surface roughness value derived by the road surface profile correction unit 113 in association with the road information acquired by the information acquisition unit 111 (FIG. 3).

This configuration enables a road surface profile that can be sufficiently evaluated to be derived independent of the driving speed of the vehicle 20 driving on the road. This configuration also enables a road surface profile of a road to be sufficiently evaluated using driving information of general vehicles without using a special vehicle for road surface profile measurement. Furthermore, users such as road management companies can estimate which roads need to be repaired based on the road surface profile output by the road surface evaluation apparatus 10 without having to visit the site, thereby reducing the cost of road management.
(2) Each of the plurality of vehicles 20 includes the vehicle speed sensor 35 that detects a driving speed. The information acquisition unit 111 acquires the speed information indicating the driving speed detected by the vehicle speed sensor 35. This allows the road surface roughness value to be derived based on an accurate driving speed, and the road surface profile can be evaluated with high accuracy.
(3) The information acquisition unit 111 calculates the driving speed of the vehicle 20 on the basis of a change in position of the vehicle 20 over time which is indicated by the position information included in the driving information, and acquires the speed information. This eliminates the need to acquire the speed information from the in-vehicle device 30 of the vehicle 20 via the communication control unit 115. As a result, the amount of data communication with the vehicle 20 can be reduced.

The above embodiment can be modified into various examples. Hereinafter, modification examples will be described.

Normally, even when a plurality of vehicles 20 travel on the same road, the road surface roughness values derived by the road surface profile derivation unit 112 may differ when the models or grades of the vehicles 20 are different. The reason for this is that the suspension, tires, and other components installed in the vehicles 20 that affect the vehicle's motion are different for each model and grade. In consideration of this point, in the present modification, the road surface profile derivation unit 112 corrects the lateral acceleration included in the driving information (acceleration information) of the vehicles 20 according to the models and grades of the vehicles 20, and then performs the derivation of the road surface roughness values.

In general, the lower the shock-absorbing performance (vertical shock absorption performance) of the suspension and tires, the more easily shocks and vibrations caused by uneven road surfaces are transmitted to the vehicle, and the greater the lateral acceleration detected by the acceleration sensor 33 on the vehicles 20. Usually, the shock-absorbing performance of suspension and tires increases with the grade between the same models, and with the ride comfort between different models. This causes variation in the lateral acceleration detected in the vehicles 20, even when the vehicles 20 travel on the same road. As a result, road surface roughness value cannot be adequately evaluated.

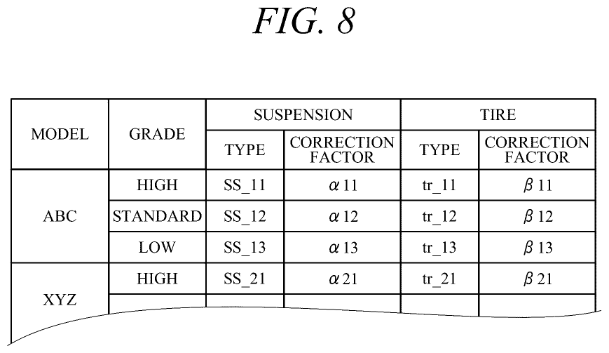

The information acquisition unit 111 identifies models and grades of the vehicles 20 on the basis of the vehicle IDs (for example, VIN numbers) of the vehicles 20 associated with the driving information, and acquires vehicle information corresponding to the identified models and grades. The vehicle information is stored in advance in the memory unit 120. The vehicle information includes a correction factor (correction factor in FIG. 8) to be described later. The road surface profile correction unit 113 corrects the lateral acceleration indicated by the driving information (acceleration information) of each vehicle 20, using the correction factor included in the vehicle information acquired by the information acquisition unit 111.

FIG. 8 illustrates an example of the vehicle information. As illustrated in FIG. 8, the vehicle information includes unique information including information that can identify types of predetermined components constituting the vehicles and the correction factors corresponding to these types, in association with the models and grades of the vehicles. The predetermined components constituting the vehicles 20 are components that affect the motion of the vehicles 20 while driving, such as suspension and tires. The types of components are, for example, the types of suspension distinguished by a spring rate or the like, and the types of tires distinguished by flatness, width, or rubber hardness.

The correction coefficients of the vehicle information are determined in advance by driving the vehicles 20 of different models and grades on a predetermined road (for example, road RD in FIG. 4A) and based on the ratio of accelerations detected by the acceleration sensors 33 of the vehicles 20 while driving. In the example illustrated in FIG. 8, the correction coefficients for suspension are α11, α12, α13, and α21. Similarly, the correction coefficients for tires are β11, β12, β13, and β21. For example, when the model of a vehicle 20 is “ABC” and the grade is “low”, the information acquisition unit 111 reads α13 as the correction coefficient for suspension and β13 as the correction coefficient for tires from the vehicle information. The road surface profile derivation unit 112 multiplies those correction coefficients by the lateral acceleration indicated by the driving information (acceleration information) of each of the vehicle 20. The road surface profile derivation unit 112 thus corrects the lateral acceleration contained in the driving information (acceleration information) of each of the vehicles 20, and then derivates the road surface roughness values. This configuration allows the derivation of road surface profiles that can be adequately evaluated independent of the types of the vehicles 20 driving on the road.

The above embodiment can be modified into various forms. Hereinafter, modifications will be described. In the above embodiment, the information acquisition unit 111 acquires the lateral acceleration of the vehicle 20 detected by the acceleration sensor 33 as information indicating the motion of the vehicle 20 as the driving information acquisition unit, but the information indicating the motion of vehicle 20 is not limited to the lateral acceleration of the vehicle 20 detected by the acceleration sensor. In other words, any configuration of the information acquisition unit 111 may be used, such as that detecting the front/rear acceleration, as long as it acquires information indicating the motion of the vehicle 20.

In the above embodiment, the information acquisition unit 111 functions as a map information acquisition unit to acquire, from the memory unit 120, map information including information about the road on which the vehicles 20 travel, but the map information may be stored on an external server or an external storage device. That is, any configuration of the map information acquisition unit may be used as long as the unit acquires map information including information about a road on which the vehicle 20 travels. In the above embodiment, the information acquisition unit 111 functions as a vehicle information acquisition unit to acquire vehicle information including unique information of the vehicle 20 from the memory unit 120, but the vehicle information may be stored on an external server or external storage device.

In the above embodiment, the road surface profile correction unit 113 functions as a roughness value correction unit to correct the road surface roughness value derived using a correction factor Kn by the road surface profile derivation unit 112 functioning as a roughness value derivation unit. However, the roughness value correction unit may correct a road surface roughness value using an expression or a table for correction instead of the correction factor Kn.

The road surface profile correction unit 113 may correct the road surface roughness value derived by the road surface profile derivation unit 112, on the basis of a vehicle speed detected by the vehicle speed sensor 35 and a steering angle detected by the steering angle sensor 34. When the vehicle 20 travels on a curved road, the acceleration sensor 33 detects not only the lateral acceleration due to the unevenness of the road surface, but also the lateral acceleration due to centrifugal force generated according to the speed and the steering angle of the vehicle 20. Therefore, in such a case, the road surface profile correction unit 113 may correct the road surface roughness value to eliminate a component based on the lateral acceleration due to the centrifugal force from the road surface roughness value derived based on the lateral acceleration detected by the acceleration sensor 33. This enables the road surface roughness value for a road other than the straight road to be derived with high accuracy.

In the above embodiment, the road surface profile output unit 114 functions as an output unit to output the road surface profile information to the user's terminal, but the output unit may output the road surface profile information to the memory unit 120 so that the road surface profile information is mapped to the map information stored in the memory unit 120. That is, any configuration of the output unit is acceptable as long as it outputs road surface profile information.

In the above embodiment, the road surface roughness values are expressed in terms of IRI, but the road surface roughness values may be expressed in terms of other indices. For example, if the road surface roughness values acquired as training data are represented in terms of an index other than IRI, the road surface profile derivation unit 112 may derive the road surface roughness values represented by that index.

The vehicle information may also include vehicle maintenance information including information relating to vehicle suspension or tire replacement. In more detail, the information indicating types of suspension or tires newly mounted on the vehicle and correction factors corresponding to the types thereof may be included in the vehicle information, in association with the vehicle identification information of the vehicle subjected to replacement of suspension or a tire. This enables the road surface roughness value derived from vehicle driving information to be corrected with high accuracy, even in the case where the replacement of the vehicle suspension or tire has been performed. In a case where the correction factor corresponding to the type of suspension or the tire with which replacement is performed is not included in the vehicle information, the road surface profile correction unit 113 causes the vehicle subjected to the replacement with the suspension or tire to travel on a predetermined road (for example, the road RD in FIG. 4A). The road surface profile correction unit 113 determines correction factors corresponding to types of newly mounted suspension and tire on the basis of the road surface roughness value derived from the driving information of the vehicle. The predetermined road used for determining the correction factor is not limited to a course for measurement. General roads may be used in determining the correction factor as long as a road surface roughness value of the road has already been derived and the road surface roughness value is highly reliable (a predetermined value or larger).

Furthermore, the road surface profile correction unit 113 may correct the road surface roughness value derived by the road surface profile derivation unit 112 on the basis of a condition of the suspension or the tire of the vehicle 20. The condition of the suspension or the tire varies depending on a period of use and other factors. In general, the longer the suspension and the tire are used, the more the shock-absorbing performance thereof deteriorates, and shocks and vibrations due to unevenness of a road surface are more easily transmitted to the vehicle. The suspension or the tire of the vehicle 20 has a certain predictable lifespan from the time of manufacture (the year of manufacture) of the vehicle 20 or the previous check time (to be more exact, the time of the previous suspension or the tire replacement) of the vehicle. Therefore, the road surface profile correction unit 113 identifies the year of manufacture of the vehicle 20 from the vehicle identification information of the vehicle 20. Alternatively, the road surface profile correction unit 113 identifies when to replace the suspension or the tire based on maintenance information. The road surface profile correction unit 113 may correct the road surface roughness value derived by the road surface profile derivation unit 112 using the correction factor (correction factor in FIG. 8) included in the vehicle information and the correction factor according to the year of manufacture of the vehicle 20 and the time of suspension or tire replacement. For example, the correction factors according to the year of manufacture of the vehicle 20 and the time of suspension or tire replacement are set to larger values as a difference between the year of manufacture or the time of replacement and the current time increases.

Note that the vehicle information may include, as unique information, information indicating the time of manufacture of the vehicle or information indicating the previous check time of the vehicle. In this case, the road surface profile correction unit 113 identifies the time of manufacture and the previous check time of the vehicle on the basis of the unique information included in the vehicle information. The vehicle information may also include, as unique information, an elapsed years (a period of use) from the start time of use (for example, a previous check time) of the suspension or the tire.

Furthermore, the vehicle information may include information indicating an integrated travel distance of the vehicle from the start time of use of the suspension or the tire. In this case, the road surface profile correction unit 113 corrects the road surface roughness value derived by the road surface profile derivation unit 112 using the correction factor (correction factor in FIG. 8) included in the vehicle information and the correction factor according to the integrated travel distance of the vehicle 20. The condition of the suspension or the tire changes depending on the integrated travel distance of the vehicle from the start time of use. In general, shock-absorbing performance of a suspension or a tire decreases as an integrated travel distance of a vehicle increases. Therefore, the correction factor according to the integrated travel distance of the vehicle 20 is set to a larger value as the integrated travel distance from the start time of use increases.

Furthermore, in the above embodiment, the road surface profile derivation unit 112 divides the driving information into speed ranges on a 10 km/h unit basis, but the road surface profile derivation unit may divide the driving information into speed ranges on a unit basis larger or smaller than the 10 km/h unit basis.

The present invention can be used as a method for evaluating a road surface which includes a process causing a computer to execute: the step (S15) of acquiring the driving information of the plurality of individual vehicles 20 which includes the acceleration information indicating accelerations of the plurality of vehicles 20 which are traveling, the speed information indicating the driving speeds of the plurality of vehicles 20, and the position information of the plurality of vehicles 20; the step (S14) of acquiring the map information including information about the road on which the vehicle 20 is driving; the step (S16) of deriving the road surface roughness value representing roughness of the road surface on which the plurality of vehicles 20 travel for each speed range on the basis of the acquired driving information of the plurality of individual vehicles 20; the steps (S17 and S18) of correcting, for each speed range, the derived road surface roughness values for each speed range, and combining the corrected road surface roughness values for each speed range to derive the corrected road surface roughness value; and the step (S19) of outputting the derived corrected road surface roughness values in association with the acquired road information.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

10 road surface evaluation apparatus, 20, 20-1 to 20-n vehicle, 30 in-vehicle device, 110 processing unit, 11 information acquisition unit, 112 road surface profile derivation unit (roughness information derivation unit), 113 road surface profile correction unit, 114 road surface profile output unit (output unit), 120 memory unit

1-9. (canceled)

10. A road surface evaluation apparatus comprising
a microprocessor configured to perform:
acquiring driving information of a plurality of vehicles which are traveling, including acceleration information indicating accelerations of the plurality of vehicles, speed information indicating driving speeds of the plurality of vehicles, and position information of the plurality of vehicles;
acquiring map information including information of a road on which the plurality of vehicles travel;
deriving a road surface roughness value representing a roughness of a road surface on which the plurality of vehicles travel for each speed range based on the driving information of the plurality of vehicles;
correcting, for each speed range, each road surface roughness value for each speed range, and combining the road surface roughness value corrected for each speed range to derive a corrected road surface roughness value; and
an output unit configured to output the corrected road surface roughness value in association with the information of the road.

11. The road surface evaluation apparatus according to claim 10, wherein
each of the plurality of vehicles includes a vehicle speed sensor configured to detect a driving speed, and
the speed information indicates the driving speeds of the plurality of vehicles detected by the vehicle speed sensor of each of the plurality of vehicles.

12. The road surface evaluation apparatus according to claim 10, wherein
the microprocessor is configured to perform
the acquiring the speed information including calculating driving speeds of the plurality of vehicles based on changes in positions of the plurality of vehicles over time which is indicated by the position information included in the driving information of each of the plurality of the vehicles to acquire the speed information of the plurality of vehicles.

13. The road surface evaluation apparatus according to claim 10, wherein
the microprocessor is configured to further perform
acquiring vehicle information including unique information of a vehicle, and
the microprocessor is configured to perform
the correcting including correcting the road surface roughness value based on the vehicle information.

14. The road surface evaluation apparatus according to claim 13 further comprising
a memory connected to the microprocessor and configured to store the vehicle information, wherein
the driving information further includes vehicle identification information, and
the microprocessor is configured to perform
the acquiring the vehicle information including acquiring the vehicle information corresponding to the vehicle identification information from the memory based on the vehicle identification information included in the vehicle information.

15. The road surface evaluation apparatus according to claim 13, wherein
the unique information includes information on type or grade of the vehicle.

16. The road surface evaluation apparatus according to claim 13, wherein
the unique information includes information indicating a time of manufacture of the vehicle or information indicating a previous check time of the vehicle.

17. The road surface evaluation apparatus according to claim 13, wherein
the unique information includes information indicating an integrated travel distance of the vehicle from a start time of use of a predetermined component affecting a motion of the vehicle which is traveling among components constituting the vehicle or a period of the use from the start time.

18. The road surface evaluation apparatus according to claim 17, wherein
the predetermined component is a suspension.
